(19) United States
(12) Patent Application Publication
(10) Pub. No.: US 2017/0053500 A1
(43) Pub. Date: Feb. 23, 2017

(54) PAPER CUTTER FOR PRINTER INTEGRATED INTO AN ELECTRONIC DEVICE, AND CORRESPONDING ELECTRONIC DEVICE

(71) Applicant: INGENICO GROUP, Paris (FR)

(72) Inventor: Cyril Janot, Grane (FR)

(21) Appl. No.: 15/240,602

(22) Filed: Aug. 18, 2016

(30) Foreign Application Priority Data
Aug. 18, 2015 (FR) 1557778

(51) Int. Cl. G07G 5/00; G06Q 20/20; B26D 1/00

(52) U.S. Cl. CPC G07G 5/00; B26D 1/0006; G06Q 20/209; B26D 2001/002; B26D 2001/006

(57) ABSTRACT

A paper cutter for a printer adapted to being integrated into an electronic device. The paper cutter is transparent and has at least some of the following optical properties: a ray arriving at a first viewing angle is at least partly refracted to arrive on said paper, and a ray arriving at a second viewing angle is totally reflected.

### 1 CROSS-REFERENCE TO RELATED APPLICATIONS

This Application claims priority to and the benefit of French Patent Application No. FR1557778, filed Aug. 18, 2015, the content of which is incorporated herein by reference in its entirety.

### 2 FIELD OF THE DISCLOSURE

The present disclosure relates to the field of electronic payment terminals and electronic cash registers, and more particularly to their receipt-printing function.

### 3 PRIOR ART SOLUTIONS

The printing of a receipt in an electronic device such as an electronic payment terminal or a cash register is done by a printer integrated into the housing of the electronic device. The printed lines cannot be read until the receipt has come out of the device. Indeed, the printer is integrated into the electronic device so as to maintain the external appearance of the device and is most usually concealed from the view of the users of the electronic device. In addition, an element used to cut the paper when the receipt has been printed, known as a paper cutter, has to be provided and is most usually made out of a metallic material so as to prevent excessively rapid wear and tear and thus ensure optimal robustness of the paper cutter.

Now, certain specific uses of an electronic payment terminal (such as for example the cash register type function) or of a cash register can be optimized by the viewing (by the merchant) of the printed lines before the receipt comes out of the electronic payment terminal (for example in order to verify the scanned data of a purchase for example). In this case, the merchant must actually make the paper of the receipt move forward in order to view the printed line outside the terminal.

A first drawback of this approach lies in the fact that there is excess consumption of paper due to repeated paper forward feed operations (about 7 mm of paper is lost at each forward feed of the receipt.)

A second drawback is that of the deterioration of the quality of service offered to the customer because the use of the electronic device caused is slowed down by repeated paper forward feed operations.

There is therefore a need for a novel technique for printing a receipt in an electronic device (of the electronic payment terminal type or cash register type), which can be used, for the merchant, to optimize the reading of the line that has just been printed on the receipt while ensuring the robustness of the electronic device and the quality of service offered to the customer.

### 4 SUMMARY

An exemplary aspect of the present disclosure relates to a paper cutter for a printer adapted to being integrated into an electronic device.

According to an exemplary embodiment, the paper cutter is transparent and is adapted to obtaining at least some of the following optical properties:
a ray arriving at a first viewing angle is at least partly refracted to arrive on the paper, and
a ray arriving at a second viewing angle is totally reflected.

Thus, an exemplary embodiment proposes a novel and inventive solution to the printing of a receipt in an electronic device (such as an electronic payment terminal or a cash register) enabling the printed receipt (at least the last printed line) to be read before it comes out of the device by the merchant positioned facing the receipt and, at the same time, preventing visibility (by total reflection on the surface of the cutter) for a person, for example a customer, placed at another viewing angle relative to the receipt.

To this end, according to an exemplary embodiment, the paper cutter associated with the printer is made transparent and given special optical properties enabling visibility that is different according to different viewing angles.

Thus, when the printer is integrated into an electronic payment terminal or into a cash register, the paper cutter according to an exemplary embodiment is transparent for the merchant facing the receipt, enabling him to see through the cutter, before the receipt comes out of the electronic payment terminal (or cash register), and view at least the last printed line (or even the last two lines depending on the height of the cutter). However, the paper cutter, according to an exemplary embodiment, does not enable a user (for example a customer) placed at another viewing angle to see through the cutter.

An exemplary embodiment thus makes it possible to control the transparency of the paper cutter according to the viewing angle so as to enable the reading of the receipt for the merchant while concealing the visibility of the receipt and of the interior of the electronic device for the customer.

According to one particular aspect, the paper cutter has a shape adapted to obtaining these optical properties.

Thus, according to this particular aspect, it is the specific shape of the paper cutter that makes it possible to obtain the desired optical properties, in enabling total reflection for a viewing angle corresponding to a customer while enabling transparency of the cutter for a viewing angle corresponding to a merchant facing the receipt being printed.

For example, the paper cutter is made of plastic and has an adapted shape that corresponds to a triangle adapted to:
obtaining an angle of less than 40° between the first viewing angle and the normal to the upper face of the paper cutter, delivering a first refracted ray;
obtaining an angle of less than 40° between the first refracted ray and the normal to the lower face of the paper cutter, delivering a second refracted ray arriving on the paper;
obtaining an angle of less than 40° between the second viewing angle and the normal to the upper face of the paper cutter delivering a third refracted ray;
obtaining an angle of more than 40° between the third refracted ray and the normal to the lower face of the paper cutter, delivering a totally reflected ray.

Thus, according to this particular embodiment, the specific shape of the paper cutter by which the desired optical properties are obtained corresponds to a triangle, the most acute angle of which enables the cutting of the paper and the upper face (flush with the surface of the electronic device) and the lower face (within the electronic device) of which enable firstly total reflection along the customer's viewing angle and, secondly, sufficient refraction to obtain visibility of the printed lines on the receipt along the merchant's viewing angle.

It is understood that any other shape suited to obtaining these desired optical properties can be implemented, especially according to the material used for the paper cutter.

Indeed, for plastic for example, it is known that a ray arriving at an angle of less than 40° relative to the normal is partly refracted whereas a ray arriving at an angle of more than 40° relative to the normal is totally reflected.

Thus, according to this embodiment, the triangular shape of a paper cutter made of plastic makes it possible to:
obtain, for a viewing angle corresponding to that of the merchant placed before the receipt, a double refraction both on the upper face and the lower face of the paper cutter, providing for visibility of the receipt being printed before it comes out of the printer;
obtain, for a viewing angle corresponding to that of the customer placed before the merchant, a total reflection on the lower face of the paper cutter (after partial refraction on the upper face), providing for opaqueness of the paper and preventing any visibility of the interior of the electronic device and of the paper beneath the cutter.

According to another particular embodiment, the paper cutter is made of plastic and a treatment is applied to at least a part of its upper face and/or its lower face to obtain these optical properties.

Thus, according to this particular embodiment, the desired optical properties (namely totally reflection for a viewing angle corresponding to a customer and transparency of the cutter for a viewing angle corresponding to a merchant facing the receipt being printed) are obtained by the application of a specific treatment to at least one face of the paper cutter, such as for example its upper face (namely the face that is flush with the surface of the electronic device).

The treatment can also be applied to the lower face of the paper cutter or to both upper and lower faces.

For example, the treatment belongs to the group comprising:
an application of a polarizing film;
a deformation of the surface.

Thus, according to a first variant of this embodiment, the upper face and/or the lower face of the paper cutter is lined, partially or entirely, with a polarizing film used to obtain the desired optical properties.

According to a second variant of this embodiment, the upper face (and/or the lower face) of the paper cutter is partially or entirely deformed so as to have rough surface features (for example small teeth or ridges) used to obtain the desired optical properties.

The present disclosure also relates to an electronic device comprising a paper cutter as described above and belonging to the group comprising:
an electronic payment terminal;
an electronic cash register.

### 5 LIST OF FIGURES

Other features and advantages shall appear more clearly from the following description of one particular embodiment given by way of a simple, illustratory and non-exhaustive example, and from the appended drawings of which:

FIG. 1 illustrates a paper cutter according to a first embodiment of the disclosure;

FIG. 2 illustrates a paper cutter according to a second embodiment of the disclosure.

### 6 DETAILED DESCRIPTION

### 6.1 General Principle

The inventors were confronted with the technical problem of optimizing the reading of a ticket being printed during the use of an electronic device (of the electronic payment terminal or cash register type), before the ticket came out of the electronic device. The problem was to achieve this goal without unnecessarily consuming paper through forward feeds and without lowering the quality of the service offered to the customer, for example through the slowing down of the transaction. To resolve this problem they first of all considered the technical solution of modifying the paper cutter so as to make it transparent.

Indeed, a transparent paper cutter makes it possible to read at least the last printed line on the ticket, when it comes out of the printer head, without waiting for the printed part of the receipt to come out of the electronic payment terminal (or cash register).

However, this approach has the drawback of also making the receipt as well as the interior of the electronic payment terminal (or cash register), especially the mechanical elements of the printer, visible also to the customer (who is usually situated before the merchant and relatively close to the electronic device).

Now, the visibility of the technical elements is, on the one hand, firstly, not interesting for the customer and lowers the aesthetic quality of the electronic device. Secondly, it may constitute to a lack of security depending on the different technical elements made visible by this transparent cutter.

The inventors therefore pursued their research to improve this solution in order to resolve the problem of reading the printed receipt before it comes out of the electronic payment terminal (or cash register) by means of a paper cutter that is transparent but at the same time does not have the drawback of making a part of the interior of the electronic payment terminal visible through this transparent paper cutter.

The principle of an exemplary embodiment therefore relies on the use of a transparent paper cutter having optical properties which, on the one hand, enable optimized viewing of the paper coming out of the printer by the person (for example the merchant) who is situated facing the printed receipt and, secondly, invisibility for the person who is situated on the other side (for example the customer).

To this end, the inventors have based their solution on known optical principles (refraction, reflection) used to define the part of a ray/light beam through different media (air and then the material of the paper cutter), in order to obtain the desired results.

For example, an exemplary embodiment described here below are based on a paper cutter made of transparent plastic material such as polymethyl methacrylate (also called PMMA) or polycarbonate (also called PC) for which it is known that:
a ray arriving at an angle of less than 40° relative to the normal to the support is partly refracted and partly reflected, and
a ray arriving at an angle of more than 40° relative to the normal to the support is totally reflected.

It is understood that, for other materials used for the paper cutter, such as for example glass which can be transparent, these optical principles are different and lead to different embodiments of the general principle, not described herein but technically within the capability of those skilled in the art. The choice of the material used for the paper cutter can for example be determined according to different criteria such as ease of integration into the electronic device (a single plastic element for example), robustness (resistance to wear and tear due to repeated cutting of paper after each receipt has been printed), and cutting performance (for example through the use of a sufficiently hard plastic material).

Besides, the rest of this description will strive more particularly to describe the different embodiments of the disclosure for an electronic payment terminal (especially for its use as a cash register), but it is clear that the solution of the disclosure, according to these different embodiments, can be adapted to any device having the same problems, such as for example a cash register provided with a printer to print out a receipt.

Finally, the different embodiments of the disclosure are also based on data, considered to be classic or common, about the positions of the merchant and the customer relative to the electronic device and an individual's average height.

Thus, here below in the description, the electronic device (electronic payment terminal or cash register) is deemed to be placed on a support and the customer is deemed to be at a distance of about 50 cm from the electronic device. In addition, the average height of the customer and the merchant is deemed to be 1.70 m. These different pieces of input data cover the majority of situations of use of the electronic device and make it possible to consider reference viewing angles for the merchant (denoted here below as VIS1) and the customer (denoted here below as VIS2).

### 6.2 Description of a First Embodiment

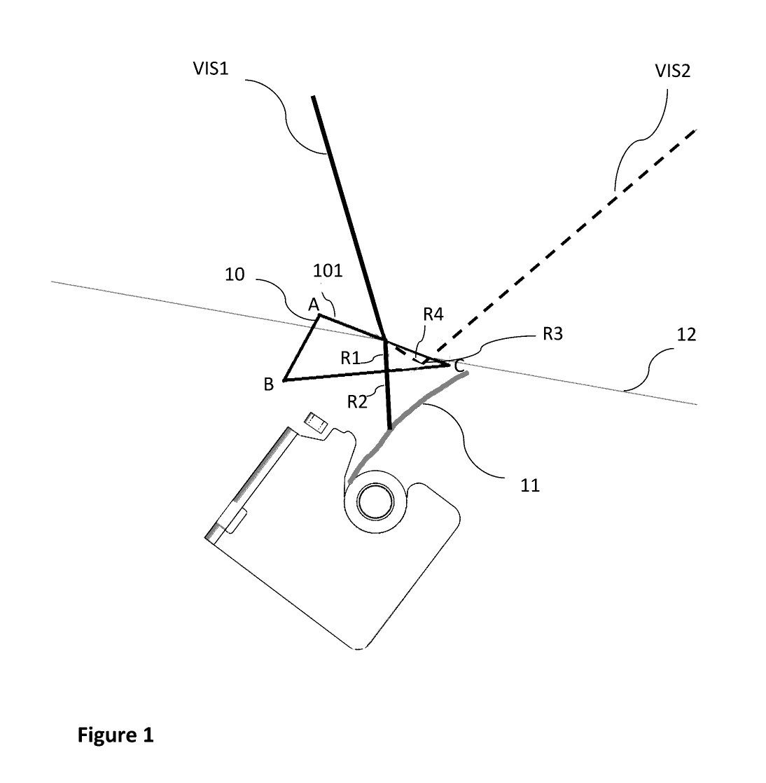

Below, referring to FIG. 1, which will describe a first embodiment of the disclosure in which the shape of the transparent paper cutter is optimized so that the viewing angle of the merchant facing the receipt enables optimized viewing of this receipt when it comes out of the printer while at the same time concealing it for the customer who is facing the merchant.

To this end, this embodiment is therefore based on the determining of a specific shape, a triangle, of the paper cutter so that certain conditions relative to the angles formed by the merchant's eye and the different faces of the cutter are met with in order to enable the merchant to read the receipt through the cutter while at the same time meeting other conditions relative to angles formed by the customer's eye and the different faces of the cutter to prevent the customer from seeing through the cutter.

FIG. 1 therefore represents the viewing angles VIS1 and VIS2 respectively of the merchant and the customer as well as the triangular paper cutter 10 and the paper 11 before it comes out of the electronic device represented by a surface 12.

According to this first embodiment, the angles A, B and C of the paper cutter 10 are determined so as to obtain:
on the merchant side (VIS1):
   an angle of less than 40° between his viewing angle (VIS1) and the normal to the upper face (AC) to obtain a first refracted ray (R1);
   an angle of less than 40° between the first refracted ray R1 and the normal to the lower face (CB) to obtain a second refracted ray (R2) that can reach the paper thus making it possible for the merchant to read the receipt before it comes out of the electronic device;
on the customer's side (VIS2):
   an angle of less than 40° between his viewing angle (VIS2) and the normal to the upper face (AC) to obtain a third refracted ray (R3);
   an angle of more than 40° between the third refracted ray (R3) and the normal to the lower face (CB) to obtain a totally reflected ray (R4) thus making it impossible for the customer to have visibility through the paper cutter.

FIG. 1 illustrates a particular shape of the paper cutter used to obtain the desired results in terms of visibility or non-visibility depending on the viewing angle, while at the same time taking account of the architecture of the electronic device in which the printer and the paper cutter are integrated while ensuring optimum performance of the paper cutter. Thus, the choice of the angles of the triangle formed by the paper cutter must also provide for an angle C that is acute enough to fulfill the function of cutting the paper.

This first embodiment of the disclosure therefore makes it possible to obtain the desired result in terms making the receipt visible to the merchant, through the paper cutter, before it comes out while at the same time ensuring the opaqueness of the paper cutter to the customer, making it possible not to lower the aesthetic quality of the electronic device and ensuring the robustness of the paper cutter through the choice of a sufficiently hard material.

### 6.3 Description of a Second Embodiment

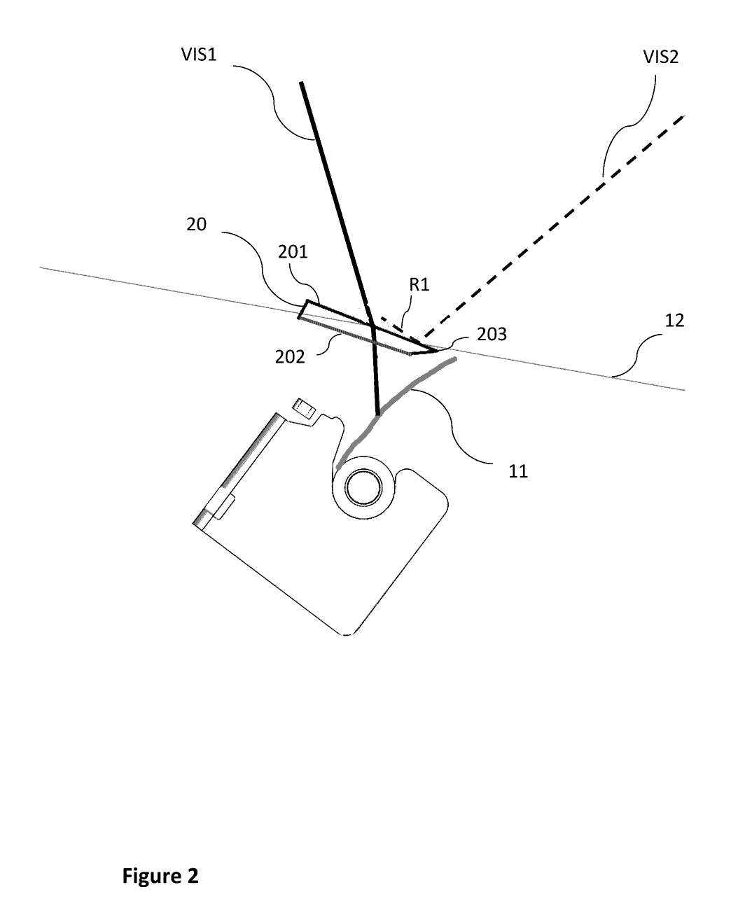

Referring now to FIG. 2, a second embodiment of the disclosure is described in which the transparent paper cutter has undergone a treatment on at least one of its faces so that, depending on the viewing angle of the merchant facing the receipt, an optimized vision of this receipt coming out of the printer is offered to the merchant while it is concealed from the customer who is facing the merchant.

FIG. 2 therefore also represents the viewing angles VIS1 and VIS2 of the merchant and the customer respectively as well as the triangular paper cutter 20 and the paper 11 before it comes out of the electronic device represented by a surface 12.

This second embodiment based on the application of a treatment on the upper face 201 and/or the lower face 202 of a paper cutter 20 enables the designing of such a cutter with a shape that can be close to a shape conventionally used for a paper cutter (with the tip 203 used to cut the paper). Indeed, it is the treatment applied to one and/or the other of the faces of the cutter that gives it its optical properties and not its particular shape as in the first embodiment described above.

More particularly, FIG. 2 illustrates a first variant of this second embodiment in which only the upper face 201 has any particular treatment, for example by application of a polarizing film (known to those skilled in the art). This polarizing film is also designed to enable compliance with the conditions of visibility and non-visibility desired, and thus makes it possible to:
obtain at least a partial refraction of a ray arriving at the upper face of the paper cutter at the merchant's viewing angle VIS1 so as to enable him to see what is printed on the receipt through the cutter before this receipt comes out of the electronic device;
obtain a total reflection of a ray reaching the upper face of the paper cutter at the customer's viewing angle VIS2, in the form of a ray R1 so as to prevent the customer from seeing through the paper cutter.

A second variant of this second embodiment, which is not shown, consists in applying a polarizing film both to the upper face 201 and the lower face 202. Such a variant can for example be implemented when the constraints such as the shape of the paper cutter, the manufacturing costs of the electronic device, etc. must be taken into account and must not allow the desired results to be obtained by the application of a polarizing film to the upper face alone.

A third variant of this second embodiment, which is not illustrated, consists in deforming one and/or the other of the upper faces 201 and 202 of the paper cutter so as to give them the desired optical properties. For example, the deformation can be considered to form ridges or small teeth along one or more particular axes made out of the material of the cutter.

Any other technique for applying a particular treatment to one and/or the other of the faces of the paper cutter can be implemented to obtain the desired optical properties according to the material used for the paper cutter and the above-mentioned optical principles.

This second embodiment of the disclosure also makes it possible to obtain the desired result in terms of visibility of the receipt through the paper cutter for the merchant before this receipt comes out while ensuring opaqueness of the paper cutter for the customer, making it possible not to lower the aesthetic quality of the electronic device and ensuring the robustness of the paper cutter through the use of a material chosen to be sufficiently hard.

Although the present disclosure has been described with reference to one or more examples, workers skilled in the art will recognize that changes may be made in form and detail without departing from the scope of the disclosure and/or the appended claims.

1. A paper cutter for a printer adapted to being integrated into an electronic device, said paper cutter comprising:
an upper face and a lower face, wherein the paper cutter is transparent between the upper and lower faces and comprises the following optical properties:
a ray arriving at a first viewing angle is at least partly refracted to arrive on said paper, and
a ray arriving at a second viewing angle is totally reflected.

2. The paper cutter according to claim 1, wherein the paper cutter has a shape adapted to obtaining said optical properties.

3. The paper cutter according to claim 2, wherein said paper cutter is made of plastic and said adapted shape corresponds to a triangle adapted to:
obtaining an angle of less than 40° between said first viewing angle and a normal to the upper face of said paper cutter, delivering a first refracted ray;
obtaining an angle of less than 40° between the first refracted ray and a normal to the lower face of the paper cutter, delivering a second refracted ray arriving on said paper;
obtaining an angle of less than 40° between said second viewing angle and the normal to the upper face of said paper cutter, delivering a third refracted ray;
obtaining an angle of more than 40° between said third refracted ray and the normal to the lower face of said paper cutter, delivering a totally reflected ray.

4. The paper cutter according to claim 1, wherein said paper cutter is made of plastic and a treatment is applied to at least a part of its upper face and/or its lower face to obtain said optical properties.

5. The paper cutter according to claim 4, wherein said treatment belongs to the group comprising:
an application of a polarizing film;
a deformation of the surface.

6. An electronic device comprising a paper cutter according to claim 1, wherein the device belongs to the group consisting of:
an electronic payment terminal;
an electronic cash register.
